(19) United States
(12) Patent Application Publication
(10) Pub. No.: US 2007/0136086 A1
(43) Pub. Date: Jun. 14, 2007

(54) SYSTEM AND METHOD FOR PROVIDING LOCATION-BASED INFORMATION TO A MOBILE DEVICE

(76) Inventor: Brian T. Luerssen, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/549,370

(22) Filed: Oct. 13, 2006

Related U.S. Application Data
(60) Provisional application No. 60/727,409, filed on Oct. 17, 2005.

(51) Int. Cl. G06Q 99/00

(52) U.S. Cl. 705/1

(57) ABSTRACT

A computer system and method for allowing a user to request location-based information about businesses in a given area. The user accesses a location-based service over a global computer network, such as the Internet, from a client device. Examples of client devices used to access the service include Internet and/or SMS enabled cell phones, personal digital assistants (PDAs), and laptops. The user creates a text message, email message, or other message that includes one or more identifiers of the geographic area the user is interested in, as well as one or more search terms about the particular type of business the user is looking for. The system then receives the message request from the user and looks up the businesses that meet the geographic and search criteria in a database. The results of the search are then returned and displayed to the user on the client device.

### CROSS REFERENCE TO RELATED APPLICATIONS

This application claims the benefit of U.S. Provisional Patent Application No. 60/727,409 filed Oct. 17, 2005.

### FIELD OF THE INVENTION

The present invention generally relates to a system and method for receiving and processing location-based information queries. More particularly, the present invention pertains to a location-based price comparison service supported by targeted advertising accessible through the Internet or via SMS.

### BACKGROUND

In today's marketplace, new storefronts are being opened every day. Oftentimes, the consumer is not even aware that a particular store in a given area exists. When the consumer is interested in obtaining a product or service, there is no easy way for them to quickly determine what businesses are in the area to meet that particular need and at what price. This problem holds true for both the local area where the consumer lives and other areas when the consumer travels. The consumer may drive around looking for a particular type of business, go to businesses they are already familiar with, or they may look on the Internet or a telephone directory by a particular business name or category. Looking around for a particular type of business is ineffective because there may be suitable businesses that the consumer does not see because of traffic or other visibility restrictions. Using businesses that the consumer is familiar with can be problematic when there are businesses that would be better suited to meet the consumer's needs, either by better pricing or by better quality of goods and services. Using the Internet or a telephone directory can be problematic when the directories are categorized into broad geographic areas, thus requiring the consumer to filter through numerous businesses that are too far away from the location where the consumer is interested in shopping. Accordingly, a need currently exists for allowing the consumer to obtain business merchant information while on the go. The current invention is directed to meeting these and other needs.

### SUMMARY

One form of the present invention is a unique system for providing location-based information.

Yet another form includes unique systems and methods to provide information to portable devices.

Another form includes operating a computer system that has several client computers and servers coupled together over a network. At least one client computer has a user interface that is used by a user to communicate with a web server to request location-based information about businesses in a given area. The request can be submitted as a text message, an email message, or another suitable message type. At least one server is the web server that provides access to the location-based information service to the client computer. At least one server is a database server that stores at least part of the information related to the participating business locations used by the location-based information service.

Another form includes a computer system and method for allowing a user to request location-based information about businesses in a given area. The user accesses the location-based service over a global computer network, such as the Internet, from a client computer. Examples of client computers used to access the service include Internet-enabled cell phones, personal digital assistants (PDAs), and laptops, to name a few non-limiting examples. The user creates a text message or email message that includes one or more identifiers of the geographic area the user is interested in, as well as one or more search terms about the particular type of business the user is looking for. The system then receives the message request from the user and looks up the businesses that meet the geographic and search criteria. The results of the search are then returned and displayed to the user on the client computer.

This summary is provided to introduce a selection of concepts in a simplified form that are described in further detail in the detailed description and drawings contained herein. This Summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one embodiment of the present invention.

FIG. 2 is a high-level process flow diagram for the system of FIG. 1.

FIG. 3 is a process flow diagram for the system of FIG. 1 demonstrating the stages involved in processing a message and returning a result.

FIG. 4 is a process flow diagram for the system of FIG. 1 demonstrating the stages involved in receiving and handling an information submission from a user.

FIG. 5 is a simulated screen of one embodiment of the system of FIG. 1 showing a message with search criteria to be sent to the location-based information service.

FIG. 6 is a simulated screen of one embodiment of the system of FIG. 1 showing a response to the search message received from the location-based information service.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

One embodiment of the present invention includes a unique service for providing location-based business information, such as the gas stations in a given area. In a further form, the service also provides the most recent price information, such as the price per gallon on unleaded gasoline. It shall be appreciated that information about an enourmous number of businesses, of a variety of different types, offering an even larger number of products may be supplied by the service.

The user accesses the location-based service over a global computer network, such as the Internet, from a client computer, mobile device, or other computer-type device (collectively referred to as a “client device”). Examples of client devices used to access the service include cell phones, personal digital assistants (PDAs), laptops, desktops to name a few non-limiting examples. The use of other similar devices to communicate with a location-based service datacenter or web site is contemplated and desired to be protected. Applicants have incorporated many of the features disclosed herein into a fully functioning website at http://www.proxito.com, incorporated herein by reference.

To utilize the service, in one embodiment, the user creates a request, which may be formatted as a text message, that includes one or more identifiers of the geographic area the user is interested in, as well as one or more search terms about the particular type of business and/or product the user is interested in. As one non-limiting example, if a user in Indianapolis, Ind. is interested in finding gas stations in the downtown area that sell Diesel fuel, the user might send a request in the form of a text message from their mobile phone to an SMS Shortcode with “Diesel @ 46204” in the body of the message, where 46204 is the zip code which corresponds to downtown Indianapolis. The system then receives the request from the user and looks up the businesses that meet the geographic and search criteria. The results of the search are then returned and displayed to the user on the client device.

In an alternate form, the user may submit a request through a web page, accessible either through a standard web browser or through a mobile web service such as the EVDO service provided by Verizon Wireless. The user may then receive the results from the service through a variety of methods such as a web page, e-mail, or text message containing the results. No particular brand or type of computer, phone, or operating system, is required in order to access the location-based business information service, other than a client device that has a network connection and is capable of communicating properly with a particular server (such as a web server) to access the location-based business information service.

In one aspect of the invention, businesses (vendors) are included in the location-based service by paying a fee per message, a monthly subscription, and/or advertising fees for their information to be shown to users. For example, pizza chains commonly mass mail coupons and special announcements, along with using TV and car/door flyers. The money put into these promotions is significantly wasted on many people who do not want the information or never see it. By paying to be included with the location-based information service of the current invention, the business benefits because information is provided to the people who really want to see it. In addition, the service allows vendors to receive prominent inclusion in the result sets, for instance, bold or italicized fonts, or placement at the top of the result set for additional fees.

In another aspect of the invention, users are allowed to submit business and pricing information to the service, thereby further increasing the amount of available business information and increasing its current nature. As one non-limiting example, if a user encounters a lunch special at a local pizza parlor they may submit the special to the service for inclusion in the database and subsequent distribution to others. In a futher form, the service screens the information submitted by the users prior to including it in the database. In this way, the accuracy of the information stored in the database and distributed to the users upon request is maintained. In a still further form, the service may allow the submission of information from a select group of trusted users without review prior to being added to the database.

In yet another aspect of the invention, businesses provide access to their current pricing information through a web interface or other communication method. In an alternate form, pricing information is transmitted to the service by at least one business periodically, such as hourly, daily, or weekly.

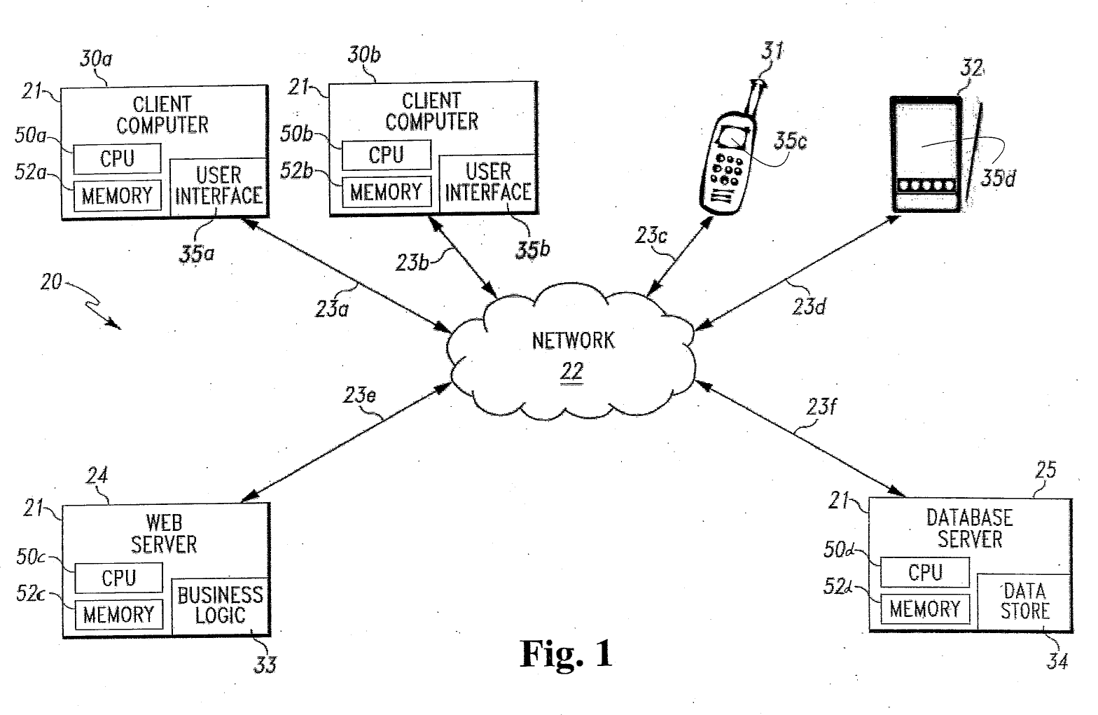

FIG. 1 is a diagrammatic view of computer system 20 of one embodiment of the present invention. Computer system 20 includes computer network 22. Computer network 22 couples together a number of computers 21 and client devices 30 over network pathways 23a-f. More specifically, system 20 includes client devices 30, namely client computers 30a-30b, cell phone 31, and PDA 32. System 20 also includes several other computers (collectively 21) namely Web Server 24 and Database Server 25. While computers 21 are each illustrated as being a server or client, it should be understood that any of computers 30 may be arranged to include both a client and server. Mobile phone 31 and PDA 32 may be mobile web enabled and/or SMS enabled devices. Furthermore, it should be understood that while four computers 21 and two client devices 31 and 32 are illustrated, more or fewer may be utilized in alternative embodiments.

Computers 21 include one or more processors or CPUs (50a, 50b, 50c, and 50d respectively) and one or more types of memory (52a, 52b, 52c, and 52d respectively). Each memory 52a, 52b, 52c, and 52d preferably includes a removable memory device. Each processor 50a-50d may be comprised of one or more components configured as a single unit. Alternatively, when of a multi-component form, a processor 50a-50d may have one or more components located remotely relative to the others. One or more components of each processor 50a-50d may be of the electronic variety defining digital circuitry, analog circuitry, or both. In one embodiment, each processor 50a-50d is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory 52a-52d (removable or generic) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Although not shown to preserve clarity, in one embodiment each computer 21 and device 30 is coupled to a display and/or includes an integrated display. Computers 21 may be of the same type, or a heterogeneous combination of different computing devices. Likewise, displays may be of the same type, or a heterogeneous combination of different visual devices. Although again not shown to preserve clarity, each computer 21 or device 30 may also include one or more operator input devices such as a keyboard, mouse, track ball, stylus, and/or microtelecommunicator, to name just a few representative examples. Also, besides a display, one or more other output devices may be included such as a loudspeaker or printer. Various display and input device arrangements are possible.

Computer network 22 can be in the form of a wireless or wired Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers 21 and client devices 30 can be coupled together by computer network 22.

In one embodiment, system 20 operates at one or more physical locations where Web Server 24 is configured as a web server that hosts application business logic 33 for a location-based business information service, Database Server 25 is configured as a database server for storing relational and other data 34 for the location-based business information service, at least one of client devices 30 are configured for providing a user interface 35a-35d, respectively, for accessing the location-based business information service, and at least one of client devices 30 is configured for providing one or more administrators with access to the location-based business information service settings. User interface 35a-35d of client devices 30 can be an installable application such as one that communicates with Web Server 24, can be browser-based, can be a thick or smart client, and/or can be embedded software, to name a few non-limiting examples. In one embodiment, software, such as email or text messaging software installed locally on client devices 30 is used to communicate with Web Server 34. In another embodiment, Web Server 24 provides HTML pages, data from web services (such as those based on the SOAP protocol), and/or other Internet standard or company proprietary data formats to one or more or devices 30 when requested. One of ordinary skill in the art will recognize that the term Web Server 24 is used generically for purposes of illustration and is not meant to imply that network 22 is required to be the Internet. As described previously, network 22 can be one of various types of networks as would occur to one of ordinary skill in the art. Database (data store) 34 on Database Server 25 can store data such as scores and data about participating businesses, business locations and hours, product and pricing information, etc.

Typical applications of system 20 would include more or fewer client devices 30 of varying types at one or more physical locations, but four have been illustrated in FIG. 1 to preserve clarity. Furthermore, although two servers 24 and 25 are shown, it will be appreciated by those of ordinary skill in the art that the one or more features provided by Web Server 24 and Database Server 25 could be provided by the same computer, an array of computers, or varying other arrangements of computers at one or more physical locations and still be within the spirit of the invention. Farms of dedicated servers could also be provided to support the specific features if desired.

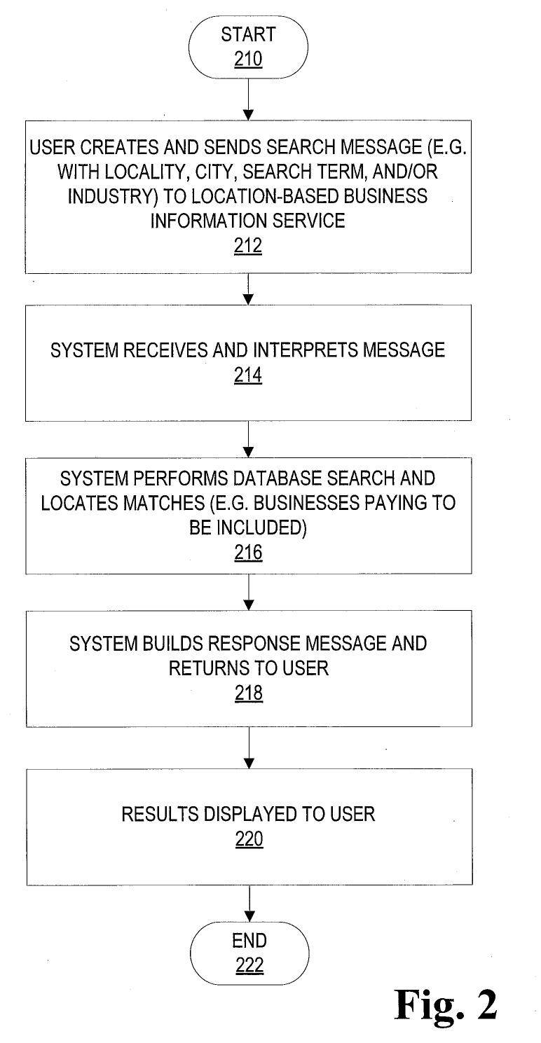

Referring also to FIG. 2, one embodiment for implementing system 20 is illustrated in flow chart form as procedure 210, which demonstrates one form of a high-level process for the system of FIG. 1. In one form, procedure 210 is at least partially implemented in the operating logic of system 20. Procedure 210 begins on FIG. 2 at start point 212 with the user creating and sending a search message from one of client devices 30a-30d to the location-based business information service on Web Server 24 (stage 214). The search request message includes one or more pieces of information that identify the type of business the user is interested in as well as a particular geographic area in which the user is either interested or located. As one non-limiting example, the message can include a geographic area, such as that defined by a zip code, city, area, locality, and/or direction (i.e. N/W/S/E). Additionally, the message preferably includes keywords identifying an industry, product, service, or business type. In the illustrative embodiment, one or more of these search terms are included in the body of the text message, search field, or e-mail message being sent.

In the illustrative embodiment, users can search within four levels of geographic specificity: localities, zip codes, city areas, and directions. Localities are small community-level geographic areas. For example, localities may be Keystone, Eagle Creek, or Fountain Square. City areas are larger areas of a city. A few non-limiting examples of areas in Indianapolis may be Downtown, Broad Ripple, Carmel, Castleton, and so on. In larger cities like New York, the service may use the different burroughs as areas. Directions may also be utilized, including North, East, South, and West to describe larger areas of a city. In a further form, the user may be allowed to create customized areas, such as by enclosing an area of a map, by defining bounding streets, or by designating an origin and corresponding radius. Once defined, the user may then create a custom name for the defined area and conduct subsequent searches within the area.

In an alternate form, location information obtained by the user's device is incorporated into the message to provide the service with a location context. This location information may be obtained from an IP address, wireless LAN defined location, GPS data, cell-tower triangulation, or any other method known to one of skill in the art.

After the user finishes creating the search message, the message is sent to Web Server 24 (stage 212). Web Server 24 receives and interprets the message using business logic 33 (stage 214). Web Server 24 then performs a search against data store 34 on Database Server 25 to locate businesses that match the search criteria (stage 216). In one aspect of the invention, businesses are included in the data store 34 by paying a fee per message, a monthly subscription, and/or advertising fees. In such an example, the business can be required to pay a fee whenever their information is included in the response message to the user. In other variations, the service is free. Additionlly, in a further form, the service may automatically expand the breadth of a requested search to include surrounding areas or localities in the event that either no search results or insufficient/unsatisfactory search results are found. Web Server 24 then builds a response message and returns the response message to the user on one of client devices 30a-30d (stage 218). The results are then displayed to the user on one of user interfaces 35a-35d (stage 220). The process then ends at end point 222.

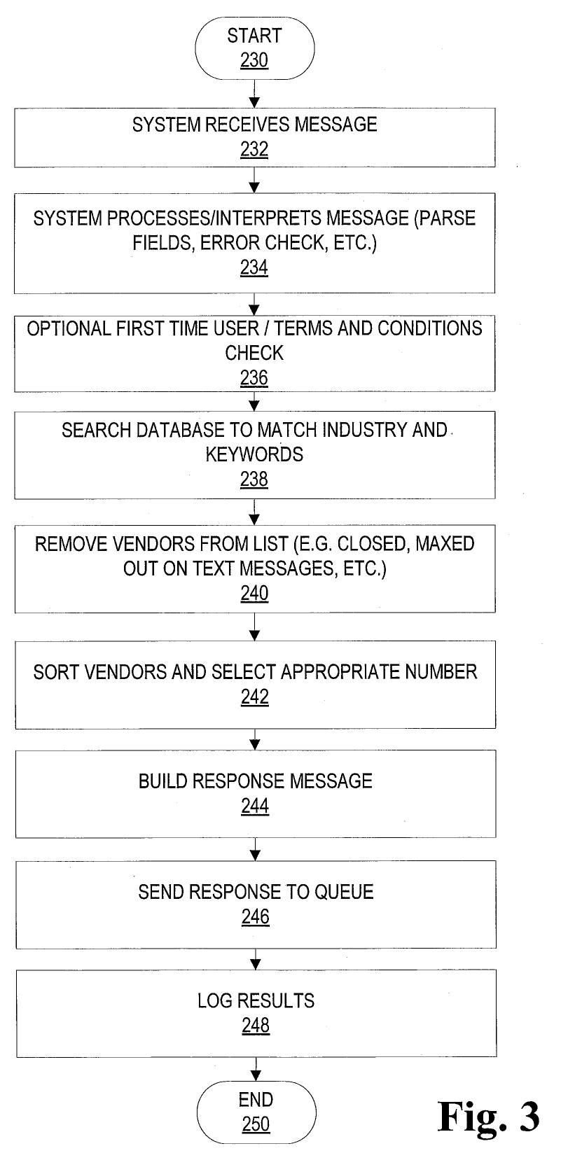

Referring now to FIG. 3, procedure 230 demonstrates one form of the more detailed stages of system 20 which involve processing the message and providing the search result. In one form, procedure 230 is at least partially implemented in the operating logic of system 20. Procedure 230 begins at start point 232 with Web Server 24 receiving the message from one of client devices 30a-30d (stage 232). Web Server 24 executes business logic 33 to process and interpret the message (stage 234). For example, the fields of the message can be parsed into the various search criteria, such as locality, city, search term, and/or industry/product keywords. Error checking can be performed to ensure that the proper format was used, such that all required fields were provided, etc. (stage 234). If all required fields were not provided, the system can proceed and use the most likely criteria, and/or the system can return an error message to the user. If desired, the system may then perform a check to see if this is a first time user and if so provide a welcome message to the user advising them that there are specific terms of service and a privacy policy located on the service provider's website that they should review. (stage 236). Web Server 24 searches Data Store 34 of Database Server 25 to match the industry/product keywords that were contained in the message (stage 238). Vendors are removed from the list, such as those having stores that are currently closed, those that have exceeded the maximum number of messages they are willing to pay for referrals from, etc. (stage 240). Vendors are sorted by a suitable sorting criteria, such as by price or by name, and the appropriate number of vendors to return are also selected (stage 242). Web server 24 constructs the response message including the search results (stage 244) and submits the response message to the outbound queue for sending back to the user (stage 246). The results of the search are then logged (stage 248), such as to a database or text file. The process then ends at end point 250.

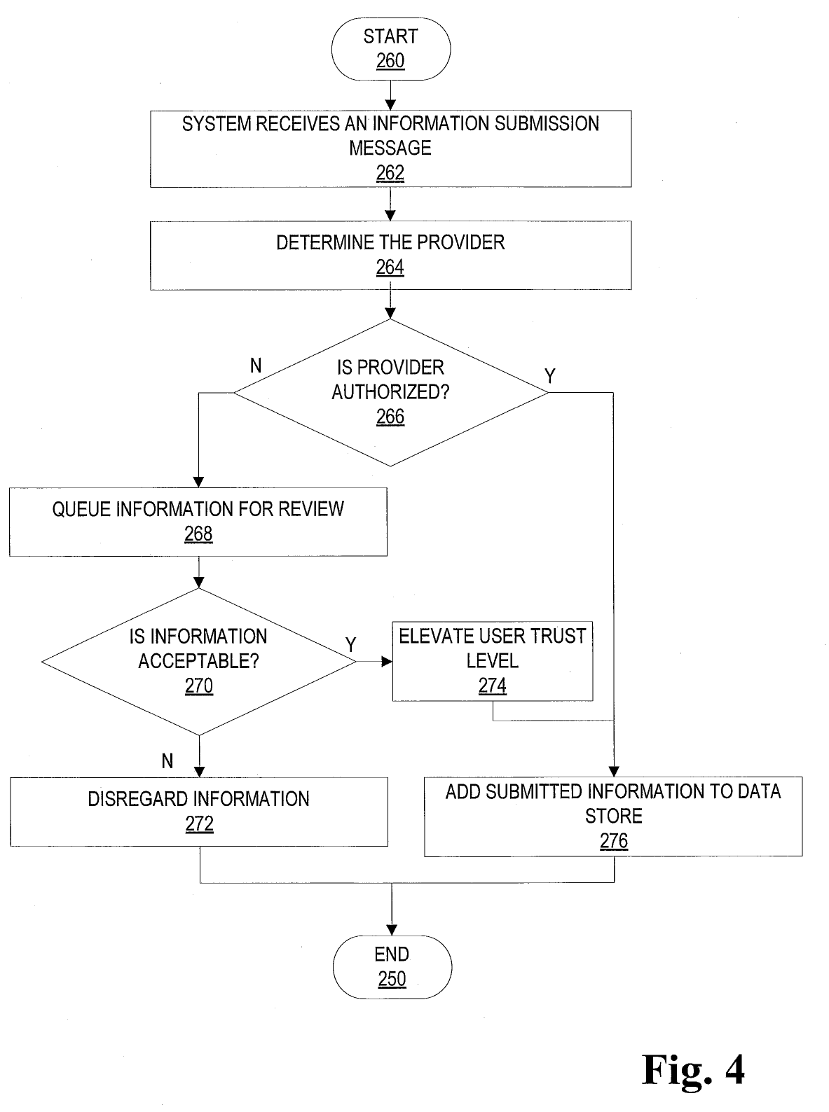

Turning now to FIG. 4 procedure 260 demonstrates one form of the more detailed stages of system 20 which involve accepting an information submission from a user and ensuring its accuracy prior to insertion into data store 34. In one form, procedure 260 is at least partially implemented in the operating logic of system 20. Procedure 260 begins at start point 262 with Web Server 24 receiving an information submission from a user (stage 262). The Web Server 24 may receive the information message through an alternate address, such as an alternate shortcode or e-mail address, or through a designated portion of a web page. The service then determines the user from who the information was sent (provider) (stage 264). The service may determine this information based upon information such as the sender's telephone number, mobile identficiation number, IP address, e-mail address, username/password combination, cookies, or any other available identification methods. Once the provider is identified, the service checks to see if the provider is authorized to submit information (stage 266) for immediate inclusion into data store 34. If the provider is authorized, then the information is entered into data store 34 and made available to requesting users (stage 270) and the process ends at endpoint 278.

If the user is not authorized to submit information without review, then the information is queued for review prior to entry into data store 34 (stage 268). The information is checked for accuracy by either an internal auditor, peer users, or some other entity (stage 270). If the information is deemed to be false, misleading, inappropriate, or otherwise unnacceptable, the information is disregarded by the service (stage 272) and the process ends. Additionally, the trust score of the provider of unnacceptable information may be depricated or the provider may be blocked from making subsequent submissions. Returning to stage 270, if the information is deemed accurate, then the trust factor associated with the provider may be elevated (stage 274) and the information is entered into data store 34 and made available to requesting users (stage 276). The process ends at end point 278.

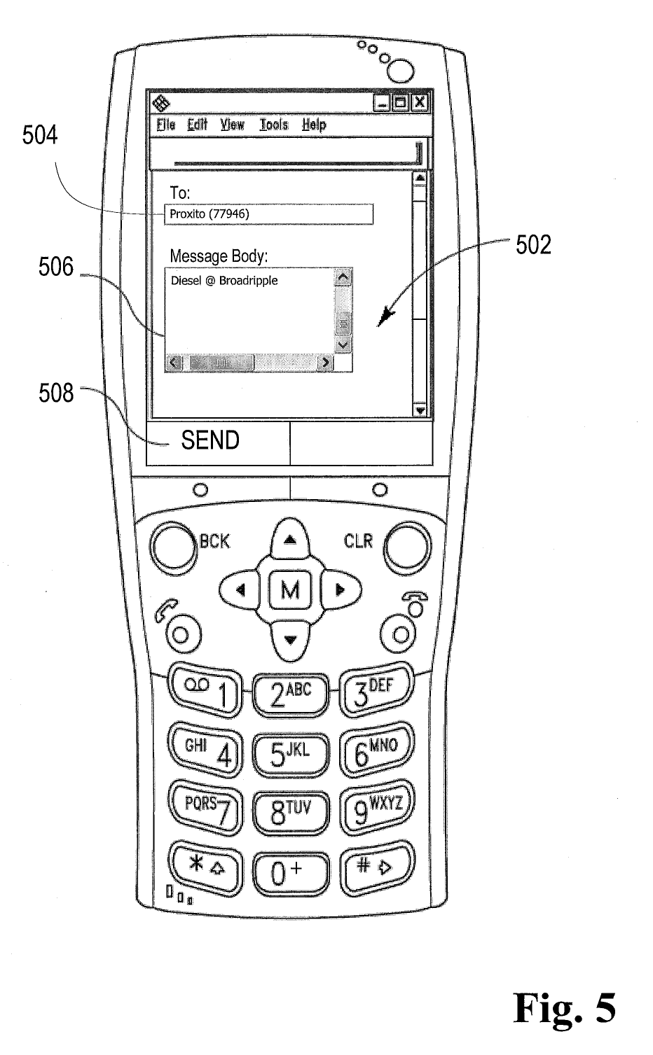

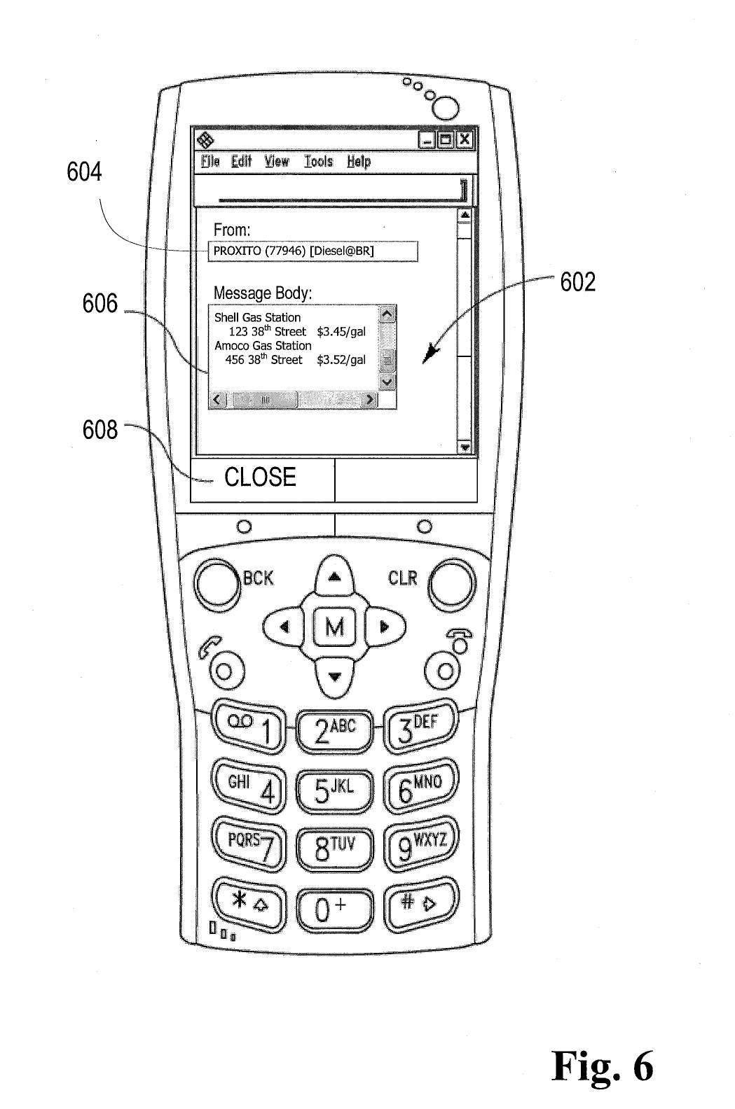

A simulated example will now be described with reference to FIGS. 5-6 to illustrate the stages of FIGS. 2-3 in further detail. One will appreciate that the sample search request and stages followed in this example are illustrative only and are not intended to be limiting in nature. Turning now to FIG. 5, a simulated screen 502 is shown that illustrates a user creating a search request message (stage 212) utilizing a mobile phone. The message includes address 504 in the To: field which identifies the shortcode (or text message address) of the service. The body 506 of the message includes the search term (Diesel) and the locality (BroadRipple) in which the user wants to search. The message can be sent to the Web Server 24 upon clicking the Send button 508 (stage 212). The system receives and interprets the message (stage 214) and finds the businesses in the Data Store 34 that match the criteria (stage 216). A response message that includes the matching criteria is then returned to the user (stage 218).

Turning now to FIG. 6, a simulated screen 602 is shown that illustrates a sample search response received back from the location service on Web Server 24 (stage 218) and displayed to the user (stage 220). In one embodiment, the From: field 604 indicates the search criteria that was originally sent. The body of the message 606 includes the search results, which in this case lists the two gas stations in the selected area that sell diesel sorted in order by cheapest price. The user may exit the message using close button 608.

A person of ordinary skill in the computer software art will recognize that the client and/or server arrangements, user interface screen content, and data layouts could be organized differently to include fewer or additional options or features than as portrayed in the illustrations and still be within the spirit of the invention.

While the invention has been illustrated and described in detail in the foregoing description, the same is to be considered as illustrative and not restrictive in character, it being understood that only the preferred embodiments have been described and that all changes and modifications that come within the spirit of the invention are desired to be protected.

Hence, the proper scope of the present invention should be determined only by the broadest interpretation of the appended claims so as to encompass all such modifications as well as all relationships equivalent to those illustrated in the drawings and described in the specification.

What is claimed is:

1. A method for providing information to users, comprising the steps of:
maintaining a database storing location-based business information having a pluarlity of entries, each entry having an associated business and at least one price associated with a product or service of said business;
receiving a request for information comprising a query and a geographic location from a remote user through a digital network;
selecting a result set from said database based on said request and said location; and
presenting said result set to the remote user using said digital network.

2. The method of claim 1, wherein at least one entry includes the address of said associated business.

3. The method of claim 1, wherein each of said plurality of entries includes the address of said associated business.

4. The method of claim 3, wherein said selecting comprises selecting a plurality of entries from said database having an associated location either within or near said geographic location.

5. The method of claim 4, wherein said selecting comprises selecting a plurality of entries from said database having an associated location surrounding said geographic location.

6. The method of claim 2, wherein said geographic location has a type selected from the group consisting of: city, area, zip code, locality, and direction.

7. The method of claim 2, wherein said geographic location is defined by the remote user.

8. The method of claim 7, wherein said geographic location is defined by enclosing an area on an electronic map.

9. The method of claim 7, wherein said geographic area is associated with a profile associated with the remote user.

10. The method of claim 1, wherein said query includes at least one keyword indicating the type of product the user is interested in.

11. The method of claim 1, wherein said request is formatted to include a @ symbol between said query and said geographic location.

12. The method of claim 1, wherein said request is sent using a web page.

13. The method of claim 12, wherein said result set is presented on a web page.

14. The method of claim 12, wherein said result set is presented in an e-mail.

15. The method of claim 12 wherein said digital network comprises the Internet.

16. The method of claim 1, wherein said request is a SMS message.

17. The method of claim 16, wherein said result set is presented in a SMS message to the remote user.

18. The method of claim 16, wherein said digital network comprises an SS7 network.

19. The method of claim 1, further comprising the steps of:
receiving current pricing information from a periodic source concerning at least one product or service associated with an entry; and
updating said price in said database.

20. The method of claim 19, wherein said periodic source is the business associated with said entry in said database.

21. The method of claim 19, wherein said current pricing information in received over the Internet.

22. The method of claim 1, wherein said geographic location is determined using GPS.

23. The method of claim 1, wherein said geographic location is determined using a wireless hotspot.

24. The method of claim 1, wherein said geographic location is determined by the operator of said digital network.

25. The method of claim 24, wherein said operator is a cell phone service provider.

26. The method of claim 1, further comprising the steps of:
receiving current pricing information relating to at least one product and at least one business from a remote user;
determining is the user is a trusted user by assessing a trust index associated with said user; and
sending said current pricing information for accuracy review or approval prior to entry into said database if said user is not trusted; or
adding said current pricing information to said database if said user is trusted.

27. The method of claim 26, further comprising the steps of:
determining that said current pricing information for the user is accurate; and
increasing the trust index of the user in response to said determining.

28. The method of claim 26, wherein said trust index is associated with a profile associated with the user.

29. A system comprising:
a first server maintaining a database containing location-based business information updated with information received from at least one source;
a second server capable of receiving a request for location-based business information over a digital network, communicating with said first server to execute said query, and sending a formatted result set to the user over said network; and
a mobile device capable of sending said request to said second server over said network and receiving and displaying said formatted result set.

30. The system of claim 29, wherein said mobile device is a cell phone.

31. The system of claim 29, wherein said mobile device is a PDA.

32. The system of claim 29, wherein said source is said mobile device.

33. The system of claim 29, wherein said formatted result set is sorted by price.

34. A method for providing information to users over mobile devices, comprising the steps of:
maintaining a database storing location-based business information having a pluarlity of entries, each entry having an associated business and at least one price associated with a product or service of said business;
receiving a request for information comprising a query and a geographic location in the form of a Short Message Service (SMS) message from a remote user using a mobile device;
selecting a result set from said database based on said request and said location; and
sending said result set in an SMS message to the remote user.
